(19) United States
(12) Patent Application Publication
(10) Pub. No.: US 2003/0125817 A1
(43) Pub. Date: Jul. 3, 2003

(54) Multiple action controller system

(76) Inventor: Frank E. Scharwat, Coupeville, WA (US)

Correspondence Address: Dean A. Craine, P.S., Suite 140, 400-112th Ave. NE, Bellevue, WA, 98004, US

(21) Appl. No.: 10/334,550

(22) Filed: Dec. 30, 2002

Related U.S. Application Data
(60) Provisional application No. 60/345,659, filed on Dec. 31, 2001.

(51) Int. Cl. G05B 11/01; G05B 9/02

(52) U.S. Cl. 700/23; 700/18; 700/19; 700/20

(57) ABSTRACT

A multiple action controller system that prevents execution of false logic commands caused by dry or wet shorts, foreign voltages or signals, open conductors, faulty connectors, or loss of power by temporarily deactivating the system's logic controller when a false logic command is received. After the false logic commands are discontinued, the logic controller is able to reset and resume normal functions. The system that can recognize multiple action identifiers located in any physical arrangement on its control conductor, and the sequence upon which they are activated. The system also monitors its control conductor in real time, for conditions that would cause the conductor to not function properly. The multiple action controller system includes a logic controller capable of carrying out a plurality of logic actions, a main conductor connected to the logic controller, a common ground, and at least one action identifier terminator terminated to the common ground and connected to the main conductor. The action identifier terminator is used to instruct the logic controller via the main conductor regarding the logic action to execute.

This is a utility patent application, which claims benefit of U.S. Provisional Application No. 60/345,659 filed on Dec. 31, 2001.

### BACKGROUND OF THE INVENTION

1. Field of the Invention

This invention pertains to logic control systems and, more particularly, to logic controller systems that detect true and false commands, automatically deactivate on false commands, and only execute true commands, while monitoring the integrity of the conductor utilized to detect commands, in real time.

2. Description of the Related Art

It is widely known that shorts, foreign voltages or signals, open conductors, faulty connectors, and loss of power can create false logic commands in logic control systems. If a false logic command is created, it can seriously damage or otherwise adversely affect equipment, or cause injuries or deaths.

An example of a critical controller system is the trigger on/off function of a hand-held tool such as an ultra high-pressure water-jetting gun. At pressures of 40,000 PSI or more, an accidental or unwanted activation of the trigger could be fatal to the operator. Currently, pneumatic systems are used which require an “air over water” valve to be located a short distance from the gun. Unfortunately, such systems are slow to activate and deactivate and not fail-safe.

Another example of a critical controller system is a hand-held control pendant that has a variety of control functions enclosed within, connected to a main piece of equipment by a multiple conductor wire cable. Typically, there can be fifteen independent control functions that are controlled from the pendent. In order to control these functions, a cable made of thirty conductors or wires must be used. Because the pendent moves and the cable flexes, the cable eventually fails, resulting in the wire conductors shorting, or opening. Also, moving the cable around in the open environment makes it accessible to physical damage that can cause shorts or open conductors. When the control cable fails, it can cause damage to the system being controlled, causing unwanted control functions to be entered into the equipment or resulting in injury to operators.

What is needed is an improved logic control system that is able to detect false commands created by shorts, open circuits, faulty connectors, or a bad conductor circuit and deactivate with out executing a wrong command.

### SUMMARY OF THE INVENTION

It is an object of the present invention to provide a logic controller system that is able to detect faulty commands, only execute true commands and monitor in real time the integrity of its control circuit.

It is also an object of the invention to provide such a logic controller system that uses only one wire conductor, or a single conductor made form other conductive material, with a common ground source and that has the ability to execute one or more logic commands on the single conductor.

These and other objects of the invention which will become apparent are met by a multiple action controller system that prevents execution of false logic commands caused by shorts, foreign voltages or signals, open conductors, faulty connectors, or loss of power by temporarily deactivating the system logic controller when a false logic command is received, and monitors in real time the control conductor. After the false logic commands are no longer present, the logic controller resets itself and resumes normal functions. In addition to the logic controller that is capable of carrying out a plurality of logic actions, the multiple action controller system includes a logic controller, a main conductor connected to the logic controller, a common ground conductor, and at least one action identifier terminator, also referred to as AIT, terminated to the common ground conductor and connected to the main conductor. The action identifier terminator is used to instruct the logic controller via the main conductor regarding the logic action to execute.

An important benefit of the multiple action controller system is that with the action identifier terminator, all unwanted control function outputs from the controller are prevented. No power interruption, open conductor, shorted conduction, cross-shorted conduction, ground short to the conductor, water short on the conductor, foreign voltage, foreign signal, or faulty connector can cause an unwanted control function output from the controller.

Another important benefit of the multiple action controller system is that no short to ground on the conductor can cause a potential on the conductor that is acceptable to the controller, to execute a controller command other than a fault command. If another controller's conductor were shorted to the conductor, both controllers would fault. During operation, only the action identifier terminator terminated on the conductor causes an acceptable controller logic command. A foreign frequency, or voltage negative or positive, acts as a short by altering the potential of output pulse frequency on the conductor below the acceptable threshold, or by shifting the center frequency out of tolerance, this will cause the logic controller to fault the system.

Another important benefit of the multiple action controller system is that the controller will resume normal operation once the fault condition is cleared.

### DESCRIPTION OF THE DRAWINGS

FIG. 1 is a block diagram of the multiple action controller system disclosed herein.

FIG. 2 is an electrical schematic of the system.

### DESCRIPTION OF THE PREFERRED EMBODIMENT(S)

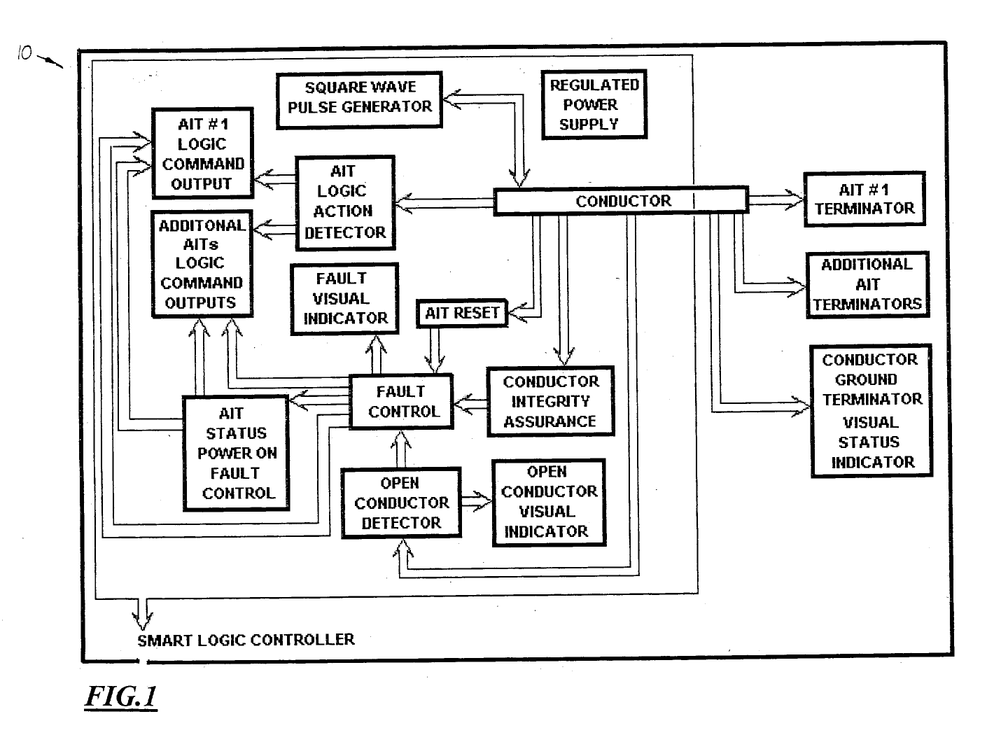

Referring to the accompanying FIG. 1, there is shown and described a multiple action controller system 10 that prevents execution of false logic commands caused by shorts, foreign voltages or signals, open conductors, faulty connectors, or loss of power by temporarily deactivating the system logic controller 15 when a false logic command is received. It also has optional features depicted here that requires the sequence activation of a first action identifier terminator (hereinafter referred to as AIT #1) before the activation of a second action identifier terminator (hereinafter referred to as AIT#20 for a logic command output, and that each AIT be un-terminated with proper re-activation, before the logic controller 15 will execute another output command, when a fault condition occurs, or any AIT is un-terminated. After the false logic commands are discontinued, the logic controller 15 is able to reset and resume normal functions.

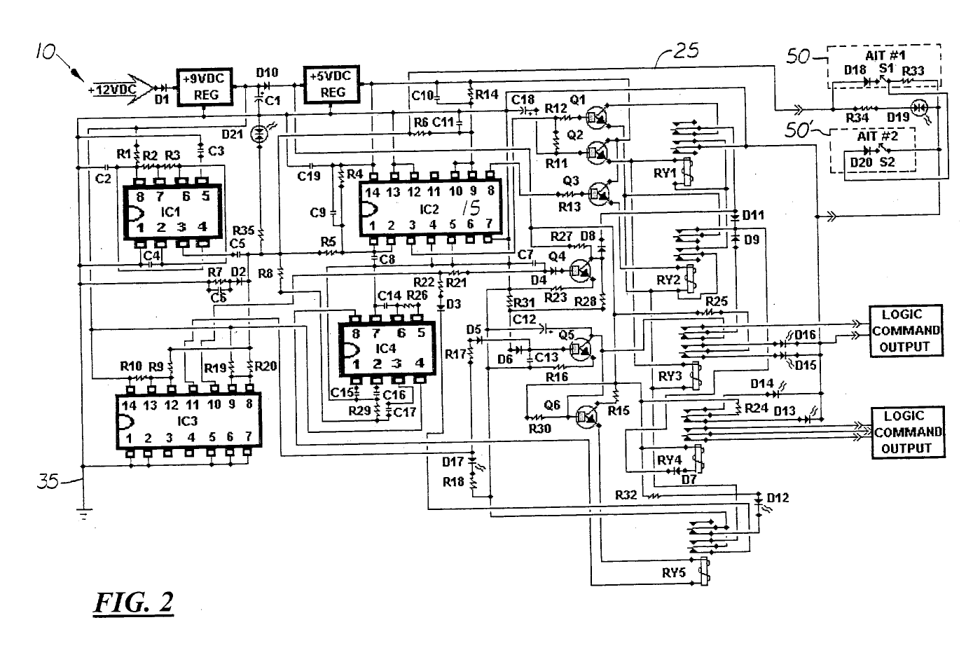

As shown in FIG. 2, the multiple action controller system 10 includes a logic controller 15 capable of carrying out a plurality of logic actions while monitoring its main conductor 25, a main conductor 25 connected to the logic controller 15, a common ground conductor 35, and at least one AIT 50, or 50′ terminated to the common ground conductor 35 and connected to the main conductor 25. The AIT's 50, 50′ are used to instruct the logic controller 15 via the main conductor 25 regarding the logic action to execute.

The system 10 includes an integrated circuit, denoted IC#1, which is an LM555cn chip used to generate a square wave pulse. Its output to the conductor is through capacitor C5. A variety of frequencies can be utilized depending upon the application. In this particular controller configuration the frequency will be between 1000 and 15000 cycles. The frequency and the pulse wave shape are set by resistors R2, R3, C3, and C4. The output level, and ground feedback loop are set by resistors R7, R34, R35, capacitor C6, and diodes D2, D19, D21.

The diodes D19, D21 are bi-directional LEDs that change color state when an AIT 50, 50′ is activated. Diodes D19 and D21 are also used for visual indicators that the conductor is properly terminated, and the state change of the main conductor 25 when an AIT is activated.

The AIT 50, 50′ is a circuit consisting of a diode, or a diode and resistor. In FIG. 2, the system is depicted as having at least two AITs: AIT#1 and AIT#2. AIT #1 is made up of the components, diode D18, S1, and resistor R33. AIT #2 is made up of the diode D20 and S2.

The integrated circuit IC2 is a MM74HCT00N quad 2-input NAND GATE chip. On the first gate, pins 1 and 2 are used for AIT #1 logic action detection. An AIT is activated when it is connected to ground. When AIT #1 is activated, the diode in the AIT circuit drops, and or changes the positive potential of the carrier signal on the main conductor, towards, or to, a negative potential. The state change activates the AIT logic action detector output at pin 3 of integrated circuit IC2, which goes high at the base of transistor Q1 and Q2, therefore relay RY3 will energize and supply a control voltage source from R25, through the contacts of RY3, for a logic command out put. The AIT logic action logic detector outputs are variable outputs, as they can go to a voltage value, depending upon the AIT circuit that is activated. The variable is determined by utilizing, or not, a resistor in series with the diode in the AIT. The bias for this first gate of IC2 is set by resistors R4, R5, and capacitor C8, C9.

The second gate of the integrated circuit IC2 is not utilized, pins 4 and 5 are grounded, and pin 6 has no connection.

The forth gate of the integrated circuit IC2 is not utilized, pins 12 and 13 are grounded, and pin 11 has no connection. When AIT #2 is activated, the diode in the AIT circuit drops, and or changes the potential of the carrier signal on the main conductor, to a negative potential, causing the AIT #2 logic action detector output at pin 8, the third gate, of integrated circuit IC2 to go high at the base of transistor Q3, therefore relay RY2 and RY4 through RY2 will energize. RY4 supplies a contact closure for a logic command output.

The integrated circuit IC3 is a MC4081 bpe quad 2-input AND GATE chip. The first and second gates are not utilized, pins 1,2,5,6,7 are grounded, and pins 3,4 have no connections. Pin 10 gate 3 of integrated circuit IC3 is the reset output, which goes low when any AIT is activated. The bias for this gate is set by R19 and R20. The transistors Q1, Q4 plus capacitor C7, resistors R12, R21, R22, diodes D3, D4, the ground path through D8, RY1, D9, and RY3 contacts, plus the output of integrated circuit IC3 gate 3, make up the AIT Reset detection and Sequence detection circuit. The AIT Reset circuit output from transistor Q4, is fed to the base of transistor Q5, of the Fault Control circuit. When AIT #1 is activated first, transistor Q4 is biased off, transistor Q1 is biased on, which supplies a ground path through the un-energized contacts of RY1, which keeps the bias for Q5 low, and the Fault relay energized, also IC2 gate #1 pin 3 goes high, biases Q2 on, which energizes RY3 and supplies, through resistor R25, a logic command output. RY3 also opens the ground path for D9 through RY3 and RY2. When AIT #2 is activated before AIT #1, or at the same time, RY2 momentarily energizes before RY3, because of the delay capacitor C18, and grounds through RY3 and D9, the base of Q6, which de-energizes the Fault relay RY5 and faults the controller. With the Fault relay RY5 de-energized, the ground paths for relays RY2, RY3 and transistor Q1 through RY5 are open, allowing the bias voltage on Q5 to remain high, keeping the fault relay RY5 de-energized until every AIT (#1, #2) is de-activated.

The AIT Reset circuit activates the fault circuit when any AIT (#1 or #2) is activated before system power is turned on. In this state, when power is supplied to the controller, the output of integrated circuit IC3 pin 10 is kept low. Therefore the base of transistor Q4 is also low, allowing the base of transistor Q5 to go high, turning off transistor Q6, which keeps the fault relay de-energizing. With the Fault relay de-energized, the ground paths for relays RY2, RY3 and transistor Q1 through the Fault relay are open, allowing the bias voltage on Q5 to remain high, keeping the fault relay R5 de-energized. The system will remain faulted until every AIT (#1, #2) is de-activated. When all AITs are de-activated with the power on, the output of IC3 the third gate, pin 10, goes high, and the system 10 will resume normal operation.

The fourth gate of IC3, pins 12 and 13, are used for open conductor detection. When the conductor is open, the voltage potential on the main conductor goes more positive, which causes pin 11, the output of integrated circuit IC3 gate 4, to go high. The bias for this gate is set by resistors R9, R10. The output is fed to the base of transistor Q5 through diode D5 and resistor R17. The LED D17 is the Open Conductor Visual indicator R17, the current limiting resistor for diode D17. When this output is high, transistor Q5 is turned on, and transistor Q6 is turned off, therefore the Fault relay is de-energized, and the system is at fault. If any AIT (#1 or #2) is activated, or is still activated, before the conductor is reconnected, and remains activated when the conductor is reconnected, the system 10 will remain at fault until all AITs are de-activated. In this state, the output of integrated circuit IC3 gate 3, pin 10 is also low, therefore the Fault relay is de-energized, and the system 10 remains at fault, until all AITs are de-activated. When all AITs are de-activated, the system 10 will resume normal operation.

The integrated circuit IC4 is an LM567cn, used for conductor integrity assurance. The integrated circuit IC4 is a general-purpose tone decoder, designed to provide an internal saturated transistor switch to ground is used to monitor the main conductor all the time. When the input signal present at pin 3 is within the passband perimeters, then pin 8 provides a ground source for the Fault relay RY5. A sufficient ground source on the conductor that would keep the AIT logic action detector from functioning properly, will also cause integrated circuit IC4 to open its ground path at pin 8, this will de-energize the fault relay and illuminate the fault LED. A foreign voltage or frequency on the conductor will also cause integrated circuit IC4 to open its ground path at pin 8. The output from another controller's main conductor, if it were to be shorted to this controller's main conductor, would not only fault this controller, but it would also fault the other controller as well, even if there are AITs on either controller activated, or not. Once these conditions are removed, the system 10 will resume normal operation. Resistor R26 and capacitors C14, C15, C16 set the center frequency and bandwidth for IC4, and resistor R29 and capacitor C17 set the threshold input level for IC4.

When the system 10 is in the standby mode, the DC potential of the output of the pulse generator on the conductor has a positive value. This positive potential on the conductor keeps the outputs of gates 1 and 3 of integrated circuit IC2 low. The low DC output of gate 1, pin 3, of integrated circuit IC2, keeps transistors Q1 and Q2 off, which keeps the relay RY3 non-energized. Also, the frequency riding on the conductor activates the ground path through integrated circuit IC4 for the fault relay RY5. The DC output of gate 3 of IC2, pin 8, is also low. This positive potential on the conductor also keeps gate 3, pin 10 of IC3 high, turns on transistor Q4, which keeps transistor Q5 off, which keeps transistor Q6 on, and the fault control relay RY5 energized.

When a logic command output relay is energized, other logic command output relays can be allowed, or disallowed to energize when their appropriate AIT is activated, depending upon the functional requirements of the specific application requirements of the system 10, by either opening or not opening the ground or power path to the other logic command output relays, with another activated logic command, or by setting a different activation level, or by utilizing additional IC gates.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its for's or modifications within the legitimate and valid scope of the amended claims, appropriately interpreted in accordance with the doctrine of equivalents.

TABLE 1

| | | | | | |
|---|---|---|---|---|---|
| R1 = 33 ohms | R2 = 5.6K | R3 = 2.7K | C1 = 220 mfd | C2 = .01 mfd | C3 = .47 mfd |
| R4 = 220K | C4 = .01 mfd | D1 = IN4004 | R5 = 48.9K | R6 = 95.6K | R7 = 1K |
| R8 = 220K | C5 = 1 mfd | R9 = 18K | R10 = 33.4K | R11 = 1k | D2 = 1n4004 |
| D3 = 1N4004 | C6 = .1 mfd | D4 = 1N4004 | R12 = 1K | R13 = 1K | C7 = .47 mfd |
| Q1 = PN2222 | R14 = 220k | R15 = 100 ohm | Q2 = PN2222 | R16 = 10 ohm | R17 = 2.2K |
| Q3 = PN2222 | D5 = 1N4004 | C8 = .47 mfd | R18 = 220 ohm | R19 = 100K | R20 = 63.7K |
| C9 = .47 mfd | C10 = .47 mfd | C11 = .47 mfd | C12 = 340 mfd | R21 = 1k | R22 = 320 ohm |
| R23 = 10 ohm | Q4 = PN2222 | R24 = 1K | Q5 = PN2222 | R25 = 1K | R26 = 100 ohm |
| R27 = 2.2K | Q6 = PN2222 | Q7 = PN2222 | R28 = 4k | R29 = 12.7k | R30 = 1K |
| D6 = 1N4004 | D7 = 1N4004 | R31 = 1.2K | R32 = 150 ohm | D8 = 1N4004 | R33 = 33 ohm |
| D10 = 1N4004 | D11 = 1N4004 | R34 = 33 ohm | R35 = 33 ohm | D9 = 1N4004 | D12 = TLBR5410 |
| D13 = MV5752 | D14 = MV5454A | D15 = MV5752 | D16 = MV5454A | D17 = MV5752 | D18 = 1N4004 |
| D19 = MV5491A | D20 = 1N4004 | D21 = MV5491A | C13 = .1 mfd | C14 = .22 mfd | C15 = .47 mfd |
| C16 = .01 mfd | C17 = .01 mfd | C18 = 220 mfd | C19 = .47 mfd | | |

RY1 thru RY5 = DS2YSDC5V

I claim:

1. A multiple action controller system, comprising:
a. a logic controller capable of carrying out a plurality of logic actions and monitors the integrity of a main conductor;
b. a main conductor connected to said logic controller;
c. a common ground conductor; and;
d. at least one action identifier terminator terminated to said common ground conductor and connected to said main conductor, said action identifier terminator used to instruct said logic controller via said main conductor a logic action to execute.

2. The multiple action controller system, as recited in claim 1, wherein only the instructions from said action identifier terminator causes an acceptable logic command to said logic controller.

3. The multiple action controller system, as recited in claim 1, further including a second action terminator terminated to said common ground and connected to said main conductor, said second action identifier terminator is used to instruct said logic controller via said main connector, a second logic action to execute.

4. The multiple action controller system, as recited in claim 3, wherein the activation of said first and second action identifier terminators are sequentially controlled so that each said action identifier terminator by un-terminated before said logic controller can execute another logic command.

5. The multiple action controller system, as recited in claim 1, wherein said logic controller includes a reset circuit that automatically resets itself after a false logic command is no longer received.

6. The multiple action controller system, as recited in claim 1, wherein said logic controller operates 1,000 and 15,000 cycles per second.

7. The multiple action controller system, as recited in claim 1, further including means for determining when said ground conductor is properly terminated.

8. The multiple action controller system, as recited in claim 1, wherein said action identifier terminator change the polarity of said main conductor.

9. A method for preventing execution of false logic commands, comprising the following steps:
a. selecting a logic controller system that includes a logic controller capable of carrying out a plurality of logic actions and monitors the integrity of its main conductor, a main conductor connected to said logic controller, a common ground conductor; and at least one action identifier terminator terminated to said common ground conductor and connected to said main conductor, said action identifier terminator used to instruct said logic controller via said main conductor a logic action to execute, and a reset circuit connected to said logic controller enabling said logic controller to reset when a false logic command is no longer received;
b. said logic controller receiving a logic command;
c. executing said logic command by said logic controller if said logic command came from said action identifier terminator, and;
d. activating said reset circuit to reset said logic controller when said logic command was not delivered by said action identifier terminator
